(19) United States
(12) Patent Application Publication
(10) Pub. No.: US 2024/0072337 A1
(43) Pub. Date: Feb. 29, 2024

(54) Thermal Management System Architecture for Metal Air Batteries

(71) Applicant: Form Energy, Inc., Someville, MA (US)

(72) Inventors: Jaime Andres Ocampo, Burlingame, CA (US); Grant Harrison Friesen, Concord, CA (US); Jhalak Joshipura Vasavada, San Ramon, CA (US)

(21) Appl. No.: 18/453,899

(22) Filed: Aug. 22, 2023

Related U.S. Application Data
(60) Provisional application No. 63/373,306, filed on Aug. 23, 2022.

(51) Int. Cl. H01M 12/02; H01M 8/04007; H01M 8/04014

(52) U.S. Cl. CPC H01M 12/02; H01M 8/04014; H01M 8/04059; H02J 3/32

(57) ABSTRACT

Systems, methods, and devices of the various embodiments may provide configurations for components of battery systems configured for thermal management. Systems, methods, and devices of the various embodiments may include a battery system with a plurality of metal-air batteries that each includes at least one air electrode, a metal electrode, a liquid electrolyte separating the at least one air electrode from the metal electrode, and a vessel including the liquid electrolyte. In various embodiments, the battery system may also include an air circulation system, a heating, ventilation, and air conditioning (HVAC) unit, and/or a liquid cooling system.

### RELATED APPLICATIONS

This application claims the benefit of priority to U.S. Provisional Application No. 63/373,306 entitled “Thermal Management System Architecture for Metal Air Batteries” filed Aug. 23, 2023, the entire contents of which are incorporated herein by reference for all purposes.

### BACKGROUND

Energy storage technologies are playing an increasingly important role in electric power grids; at a most basic level, these energy storage assets provide smoothing to better match generation and demand on a grid. The services performed by energy storage devices are beneficial to electric power grids across multiple time scales, from milliseconds to years. Today, energy storage technologies exist that can support timescales from milliseconds to hours, but there is a need for increased availability, reliability, and/or resiliency with reduced costs in energy storage systems.

This Background section is intended to introduce various aspects of the art, which may be associated with embodiments of the present inventions. Thus, the foregoing discussion in this section provides a framework for better understanding the present inventions, and is not to be viewed as an admission of prior art.

### SUMMARY

Systems, methods, and devices of the various embodiments may include configurations for power systems. Systems and methods of the various embodiments may provide configurations for components of battery systems configured for thermal management. Systems and methods of the various embodiments may include a battery system with a plurality of metal-air batteries that each includes at least one air electrode, a metal electrode, a liquid electrolyte separating the at least one air electrode from the metal electrode, and a vessel including the liquid electrolyte. The battery system may also include an enclosure housing the plurality of metal-air batteries, and an air circulation system. In some embodiments, the air circulation system may include at least one fan configured to cycle air within the enclosure, in which the plurality of metal-air batteries may be configured to push or pull conditioned air from the enclosure.

In some embodiments, at least one fan may include an exhaust blower configured to move hot air from the plurality of metal air batteries through channels to outside the enclosure. In some embodiments, the air circulation system further includes an evaporation cooler at an inlet of a duct to condition air entering the enclosure. In some embodiments, at least one fan may be positioned at the inlet of a duct entering the enclosure or at an outlet of a duct leading from the enclosure. In some embodiments, the air circulation system may also include an air heating coil, and a recirculation path valve configured to move the air heated by the air heating coil through the enclosure when operating below a threshold temperature.

The battery system according to various embodiments may include an enclosure housing the plurality of metal-air batteries, and an air circulation system that includes a heating, ventilation, and air conditioning (HVAC) unit configured to pump cooled air into the enclosure. In some embodiments, the plurality of metal-air batteries may be configured to pull the cooled air from the enclosure, and exhaust hot air.

In some embodiments, the hot air exhausted from the metal-air batteries may be vented outside the enclosure, while in some embodiments the hot air exhausted from the metal-air batteries may recirculate to the HVAC unit. Embodiment battery systems may also include at least one fan configured to move air through channels within the enclosure.

In some embodiments, the HVAC unit may include an evaporator, a compressor, a condenser, at least one fan, and a refrigerant expansion device.

The battery system according to various embodiments may include an enclosure housing the plurality of metal-air batteries, and a liquid cooling system. In some embodiments, the liquid cooling system may include a set of cooling channels on the surface of the plurality of metal-air batteries, a pump configured to move liquid through the cooling channels to condition the plurality of metal-air batteries, a heat rejection unit, and a liquid heating unit. In various embodiments the heat rejection unit and the liquid heating unit may be configured to treat the liquid used to condition the plurality of metal-air batteries. In some embodiments, the treated liquid may be recirculated to the set of cooling channels.

In some embodiments, the liquid heating unit may be a water immersion heater outside the enclosure. In some embodiments, the heat rejection unit may be a radiator and a fan. In some embodiments, the heat rejection unit comprises a cooling tower. In some embodiments, the heat rejection unit may be a chiller circuit that includes a compressor, a condenser, a chiller, a fan, and a refrigerant expansion device.

In some embodiments, the metal-air batteries may be any type metal-air batteries, non-limiting examples of which may include iron-air type battery cells, zinc-air type battery cells, and/or lithium-air battery cells.

### DESCRIPTION OF THE DRAWINGS

The accompanying drawings, which are incorporated herein and constitute part of this specification, illustrate example embodiments of the claims, and together with the general description given above and the detailed description given below, serve to explain the features of the claims.

FIG. 1 is a system block diagram of a power generation system according to various embodiments.

FIG. 2 is a system block diagram of a power generation system according to various embodiments.

FIG. 3 is a component diagram of an electrochemical cell, according to various embodiments of the present disclosure.

FIG. 4A is a schematic diagram of an example single electrochemical cell enclosure configuration in accordance with various embodiments.

FIG. 4B is an exploded diagram of internal portions of an example cell enclosure configuration in accordance with various embodiments.

FIGS. 5A-5D are schematic diagrams of example module configurations including multiple electrochemical cells in accordance with various embodiments.

FIGS. 6A-6C illustrate portions of a battery module enclosure in accordance with various embodiments.

FIGS. 7A-7C illustrate battery module enclosure configurations in accordance with various embodiments.

FIGS. 8A-8E illustrate an example module layout within an enclosure in accordance with various embodiments.

FIGS. 9A-9F illustrate an example module layout within an enclosure in accordance with various embodiments.

FIGS. 10A-10E illustrate an example module layout within an enclosure in accordance with various embodiments.

FIGS. 11A-11C are schematic diagrams of example thermal management systems for battery module enclosures in accordance with various embodiments.

FIGS. 12A-12B are schematic diagrams of example thermal management systems for battery module enclosures in accordance with various embodiments.

FIGS. 12A-12B are schematic diagrams of example thermal management systems for battery module enclosures in accordance with various embodiments.

FIGS. 13A-13C are schematic diagrams of example thermal management systems for battery module enclosures in accordance with various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims. The following description of the embodiments of the invention is not intended to limit the invention to these embodiments but rather to enable a person skilled in the art to make and use this invention.

The following examples are provided to illustrate various embodiments of the present systems and methods of the present inventions. These examples are for illustrative purposes, may be prophetic, should not be viewed as limiting, and do not otherwise limit the scope of the present inventions.

It is noted that there is no requirement to provide or address the theory underlying the novel and groundbreaking processes, materials, performance or other beneficial features and properties that are the subject of, or associated with, embodiments of the present inventions. Nevertheless, various theories are provided in this specification to further advance the art in this area. The theories put forth in this specification, and unless expressly stated otherwise, in no way limit, restrict or narrow the scope of protection to be afforded the claimed inventions. These theories may not be required or practiced to utilize the present inventions. It is further understood that the present inventions may lead to new, and heretofore unknown theories to explain the function-features of embodiments of the methods, articles, materials, devices and system of the present inventions; and such later developed theories shall not limit the scope of protection afforded the present inventions.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and, with existing equipment or activities which may be modified, in-part, based on the teachings of this specification. Further, the various embodiments and examples set forth in this specification may be used with each other, in whole or in part, and in different and various combinations. Thus, the configurations provided in the various embodiments of this specification may be used with each other. For example, the components of an embodiment having A, A′ and B and the components of an embodiment having A″, C and D can be used with each other in various combinations, e.g., A, C, D, and A, A″, C and D, etc., in accordance with the teaching of this Specification. Thus, the scope of protection afforded the present inventions should not be limited to a particular embodiment, configuration or arrangement that is set forth in a particular embodiment, example, or in an embodiment in a particular figure. Embodiments of the present invention may include systems, methods, and devices for electrochemical energy storage systems, such as metal-air battery systems.

Various embodiments may be applicable to providing a means for thermal management of metal-air battery cells, and/or modules comprising multiple metal-air battery cells, housed within an enclosure.

Various embodiments may provide devices and/or methods for use in long-duration, and ultra-long-duration, low-cost, energy storage, including in multi-day energy storage. Herein, “long duration” and “ultra-long duration” and similar such terms, unless expressly stated otherwise, should be given their broadest possible meaning and include periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. and would include long duration energy storage (LODES) systems. Further, the terms “long duration” and “ultra-long duration”, “energy storage cells” including “electrochemical cells”, and similar such terms, unless expressly stated otherwise, should be given their broadest possible interpretation, and include electrochemical cells that may be configured to store energy over time spans of days, weeks, or seasons, such as electrochemical cells sometimes referred to as multi-day energy storage (MDS) cells. As a matter of definition, the term “duration” means the ratio of energy to power of an energy storage system. For example, a system with a rated energy of 24 MWh and a rated power of 8 MW has a duration of 3 hours; a system with a rated energy of 24 MWh and a rated power of 1 MW has a duration of 24 hours. Physically, this may be interpreted as the run-time at maximum power for the energy storage system.

In general, in an embodiment, a long duration energy storage cell can be a long duration electrochemical cell. In general, this long duration electrochemical cell can store electricity generated from an electrical generation system, when: (i) the power source or fuel for that generation is available, abundant, inexpensive, and combinations and variations of these; (ii) when the power requirements or electrical needs of the electrical grid, customer or other user, are less than the amount of electricity generated by the electrical generation system, the price paid for providing such power to the grid, customer or other user, is below an economically efficient point for the generation of such power (e.g., cost of generation exceeds market price for the electricity), and combinations and variations of these; and (iii) combinations and variations of (i) and (ii) as well as other reasons. This electricity stored in the long duration electrochemical cell can then be distributed to the grid, customer or other user, at times when it is economical or otherwise needed. For example, the electrochemical cells may be configured to store energy generated by solar cells during the summer months, when sunshine is plentiful and solar power generation exceeds power grid requirements, and discharge the stored energy during the winter months, when sunshine may be insufficient to satisfy power grid requirements.

Various embodiments may provide devices and/or methods for use in bulk energy storage systems, such as long duration energy storage (LODES) systems (e.g., multi-day energy storage (MDS) systems), short duration energy storage (SDES) systems, etc. As an example, various embodiments may provide configurations and controls for batteries of bulk energy storage systems, such as batteries for LODES systems (e.g., multi-day energy storage (MDS) systems).

While various examples are discussed with reference to Li-ion and/or Fe-air, the discussion of Li-ion and/or Fe-air is used merely as an example and various embodiments encompass other combinations and permutations of storage technologies that may be substituted for the example solar+Li-ion+Fe-air discussions herein. For example, various metal-air storage technologies may be used as batteries in the various embodiments, such as zinc-air, lithium-air, sodium-air, etc.

As used herein, the term “module” may refer to a string of unit cells (e.g., a string of batteries). Multiple modules (or multiple units or cells) may be connected together to form battery strings.

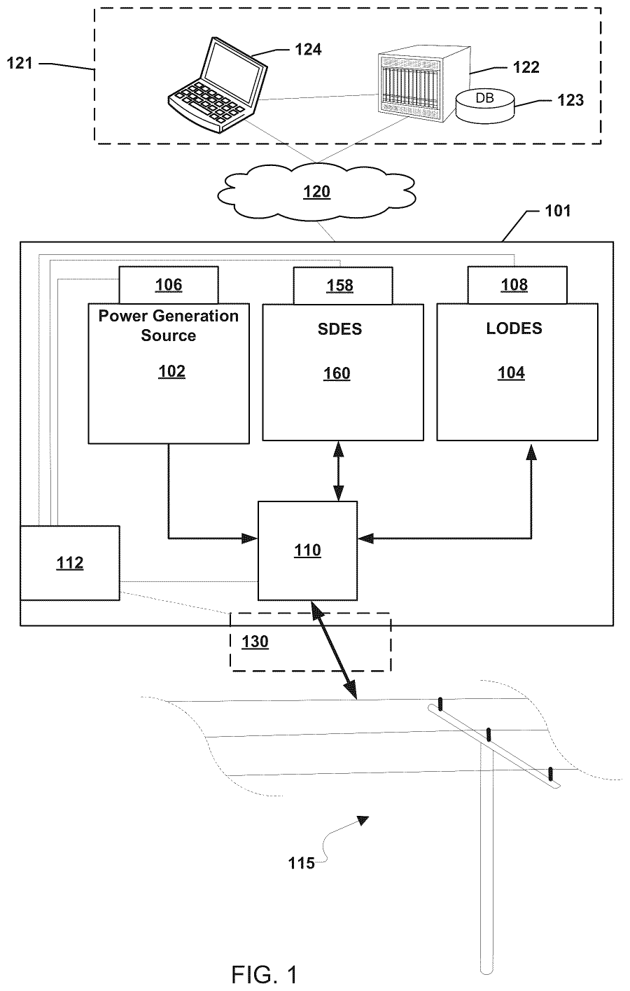

FIG. 1 is a system block diagram of a power generation system (also referred to as a power system) 101 according to various embodiments. The power generation system 101 may be a power plant including one or more power generation sources 102, one or more LODES system 104 (e.g., multi-day energy storage (MDS) systems), and one or more SDES system 160. As examples, the power generation sources 102 may be renewable power generation sources, non-renewable power generation sources, combinations of renewable and non-renewable power generation sources, etc. Examples of power generation sources 102 may include wind generators, solar generators, geothermal generators, nuclear generators, etc. The LODES system 104 may include one or more electrochemical cells (e.g., one or more batteries). The batteries may be any type of battery, such as rechargeable secondary batteries, refuellable primary batteries, combinations of primary and secondary batteries, etc. Battery chemistries may be any suitable chemistry, such as Al, AlCl₃, Fe, FeOₓ(OH)_{y}, NaₓS_{y}, SiOₓ(OH)_{y}, AlOₓ(OH)_{y}, metal-air, and/or any suitable type of battery chemistry. The SDES system 160 may include one or more electrochemical cells (e.g., one or more batteries). The batteries may be any type of battery, such as rechargeable secondary batteries, refuellable primary batteries, combinations of primary and secondary batteries, etc. Battery chemistries may be any suitable chemistry, such as Li-ion, Na-ion, NiMH, Mg-ion, and/or any suitable type of battery chemistry.

In various embodiments, the operation of the power generation sources 102 may be controlled by one or more control systems 106. The control systems 106 may include motors, pumps, fans, switches, relays, or any other type devices that may serve to control the generation of electricity by the power generation sources 102. In various embodiments, the operation of the LODES system 104 may be controlled by one or more control systems 108. The control systems 108 may include motors, pumps, fans, switches, relays, or any other type devices that may serve to control the discharge and/or storage of electricity by the LODES system. In various embodiments, the operation of the SDES system 160 may be controlled by one or more control systems 158. The control systems 158 may include motors, pumps, fans, switches, relays, or any other type devices that may serve to control the discharge and/or storage of electricity by the SDES system. The control systems 106, 108, 158 may all be connected to a plant controller 112. The plant controller 112 may monitor the overall operation of the power generation system 101 and generate and send control signals to the control systems 106, 108, 158 to control the operations of the power generation sources 102, LODES system 104, and/or SDES system 104.

In the power generation system 101, the power generation sources 102, the LODES system 104, and the SDES system 160 may all be connected to one or more power control devices 110. The power control devices 110 may be connected to a power grid 115 or other transmission infrastructure. The power control devices 110 may include switches, inverters (e.g., AC to DC inverters, DC to AC inverters, etc.), relays, power electronics, and any other type devices that may serve to control the flow of electricity from to/from one or more of the power generation sources 102, the LODES system 104, the SDES system 160, and/or the power grid 115. Additionally, the power generation system 101 may include transmission facilities 130 connecting the power generation, transmission, and storage system 101 to the power grid 115. As an example, the transmission facilities 130 may connect between the power control devices 110 and the power grid 115 to enable electricity to flow between the power generation system 101 and the power grid 115. Transmission facilities 130 may include transmission lines, distribution lines, power cables, switches, relays, transformers, and any other type devices that may serve to support the flow of electricity between the power generation system 101 and the power grid 115. The power control devices 110 and/or transmission facilities 130 may be connected to the plant controller 112. The plant controller 112 may monitor and control the operations of the power control devices 110 and/or transmission facilities 130, such as via various control signals. As examples, the plant controller 112 may control the power control devices 110 and/or transmission facilities 130 to provide electricity from the power generation sources 102 to the power grid 115, to provide electricity from the LODES system 104 to the power grid 115, to provide electricity from both the power generation sources 102 and the LODES system 104 to the power grid 115, to provide electricity from the power generation sources 102 to the LODES system 104, to provide electricity from the grid 115 to the LODES system 104, to provide electricity from the SDES system 160 to the power grid 115, to provide electricity from both the power generation sources 102 and the SDES system 160 to the power grid 115, to provide electricity from the power generation sources 102 to the SDES system 160, to provide electricity from the grid 115 to the SDES system 160, to provide electricity from the SDES system 160 and the LODES system 104 to the power grid 115, and/or to provide electricity from the power generation sources 102, the SDES 160, and the LODES system 104 to the power grid 115. In various embodiments, the power generation source 102 may selectively charge the LODES 104 and/or SDES 160 and the LODES 104 and/or SDES 160 may selectively discharge to the power grid 115. In this manner, energy (e.g., renewable energy, non-renewable energy, etc.) generated by the power generation source 102 may be output to the power grid 115 sometime after generation from the LODES 104 and/or SDES 160.

In various embodiments, plant controller 112 may be in communication with a network 120 (e.g., 3G network, 4G network, 5G network, core network, Internet, combinations of the same, etc.). Using the connections to the network 120, the plant controller 112 may exchange data with the network 120 as well as devices connected to the network 120, such as a plant management system 121 or any other device connected to the network 121. The plant management system 121 may include one or more computing devices, such as computing device 124 and server 122. The computing device 124 and server 122 may be connected to one another directly and/or via connections to the network 120. The various connections to the network 120 by the plant controller 112 and devices of the plant management system 121 may be wired and/or wireless connections.

In various embodiments, the computing device 124 of the plant management system 121 may provide a user interface enabling a user of the plant management system 121 to define inputs to the plant management system 121 and/or power generation system 101, receive indications associated with the plant management system 121 and/or power generation system 101, and otherwise control the operation of the plant management system 121 and/or the power generation system 101.

While illustrated as two separate devices, 124 and 122, the functionality of the computing device 124 and server 122 described herein may be combined into a single computing device or may split among more than two devices. Additionally, while illustrated as a dedicated part of the plant management system 121, the functionality of the computing device 124 and server 122 may be in whole, or in part, offloaded to a remote computing device, such as a cloud based computing system. While illustrated as in communication with a single power generation system 101, the plant management system 121 may be in communication with multiple power generation systems.

While illustrated as being geographically located together in FIG. 1, the power generation sources 102, the LODES system 104, and the SDES 160 may be separated from one another in various embodiments. For example, the LODES 104 may be downstream of a transmission constraint, such as downstream of a portion of the grid 115, etc., from the power generation source 102 and SDES 160. In this manner, the over build of underutilized transmission infrastructure may be avoided by situating the LODES 104 downstream of a transmission constraint, charging the LODES 104 at times of available capacity and discharging the LODES 104 at times of transmission shortage. The LODES 104 may also arbitrate electricity according to prevailing market prices to reduce the final cost of electricity to consumers.

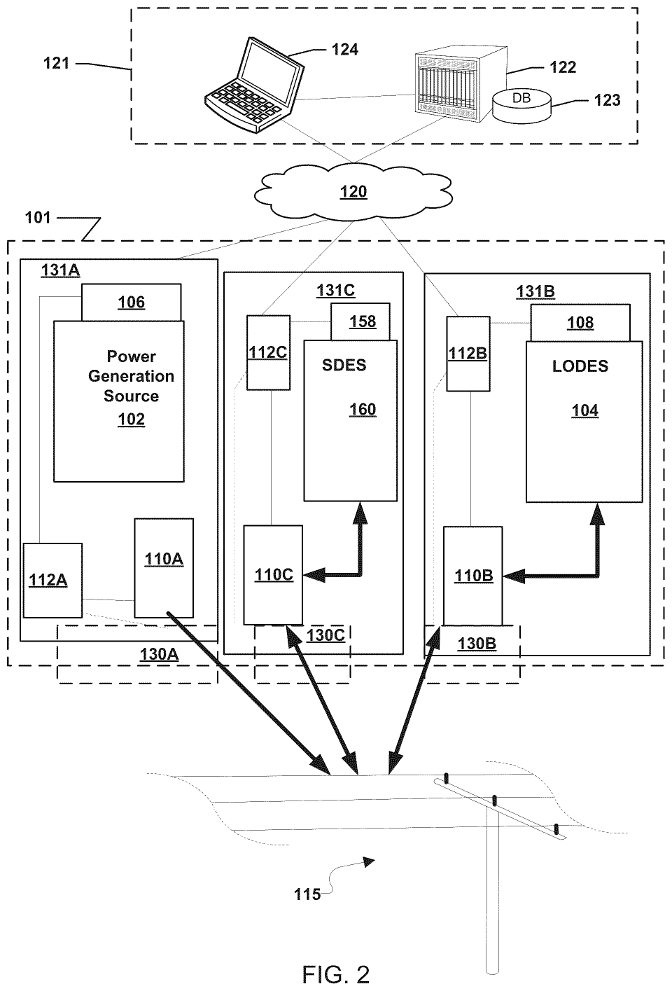

FIG. 2 illustrates an example of a power generation system 101 in which the power generation sources 102 and the bulk energy storage systems, such as the LODES system 104 and/or the SDES system 160, may be separated from one another according to various embodiments. With reference to FIGS. 1-2, FIG. 2 is similar to FIG. 1, except the power generation source 102, LODES 104, and SDES 160 may be separated in different plants 131A, 131B 131C, respectively. While the plants 131A, 131B, 131C may be separated, the power generation system 101 and the plant management system 121 may operate as described above with reference to FIG. 1. The plants 131A, 131B, and 131C may be co-located or may be geographically separated from one another. The plants 131A, 131B, and 131C may connect to the power grid 115 at different places. For example, the plant 131A may be connected to the grid upstream of where the plant 131B is connected. The plant 131A associated with the power generation sources 102 may include its own respective plant controller 112A and its own respective power control devices 110A and/or transmission facilities 130A. The power control devices 110A and/or transmission facilities 130A may be connected to the plant controller 112A. The plant controller 112A may monitor and control the operations of the power control devices 110A and/or transmission facilities 130A, such as via various control signals. As examples, the plant controller 112A may control the power control devices 110A and/or transmission facilities 130A to provide electricity from the power generation sources 102 to the power grid 115, etc.

The plant 131B associated with the LODES system 104 may include its own respective plant controller 112B and its own respective power control devices 110B and/or transmission facilities 130B. The power control devices 110B and/or transmission facilities 130B may be connected to the plant controller 112B. The plant controller 112B may monitor and control the operations of the power control devices 110B and/or transmission facilities 130B, such as via various control signals. As examples, the plant controller 112B may control the power control devices 110B and/or transmission facilities 130B to provide electricity from the LODES system 104 to the power grid 115 and/or to provide electricity from the grid 115 to the LODES system 104, etc. The plant 131C associated with the SDES system 160 may include its own respective plant controller 112C and its own respective power control devices 110C and/or transmission facilities 130C. The power control devices 110C and/or transmission facilities 130C may be connected to the plant controller 112C. The plant controller 112C may monitor and control the operations of the power control devices 110C and/or transmission facilities 130C, such as via various control signals. As examples, the plant controller 112C may control the power control devices 110C and/or transmission facilities 130C to provide electricity from the SDES system 160 to the power grid 115 and/or to provide electricity from the grid 115 to the SDES system 160, etc.

The respective plant controllers 112A, 112B, 112C and respective transmission facilities 130A, 130B, 130C may be similar to the plant controller 112 and transmission facilities 130 described with reference to FIG. 1.

In various embodiments, the respective plant controllers 112A, 112B, 112C may be in communication with the network 120. Using the connections to the network 120, the respective plant controllers 112A, 112B, 112C may exchange data with the network 120 as well as devices connected to the network 120, such as a plant management system 121, each other, or any other device connected to the network 121. In various embodiments, the operation of the plant controllers 112A, 112B, 112C may be monitored by the plant management system 121 and the operation of the plant controllers 112A, 112B, 112C, and thereby the power generation system 101, may be controlled by the plant management system 121.

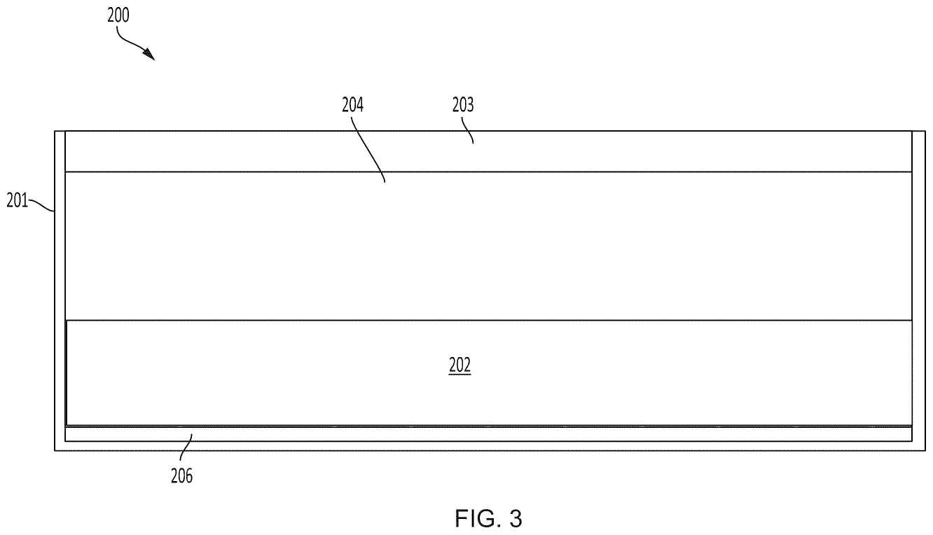

FIG. 3 is a schematic view of a battery 200, according to various embodiments of the present disclosure. With reference to FIGS. 1-3, the battery 200 may be one type of battery that may be used in a LODES 104 in various embodiments. Referring to FIG. 3, the battery 200 includes a vessel 201 in which an air electrode 203 (e.g., a cathode), a negative electrode 202 (e.g., an anode), an electrolyte 204, and a current collector 206 are disposed. The negative electrode 202 may be a metal electrode, such as an iron electrode, lithium electrode, zinc electrode, or other type suitable metal. The liquid electrolyte 204 may separate the air electrode 203 from the negative electrode 202. As examples, the battery 200 may be a metal-air type battery, such as an iron-air battery, lithium-air battery, zinc-air battery, etc. While various examples are discussed with reference to metal-air batteries, other type batteries may be substituted in the various examples and used in the various embodiments. The battery 200 may represent a single cell or unit, and multiple batteries 200 (or multiple units or cells) may be connected together to form battery strings (also referred to as modules).

In various embodiments, the negative electrode 202 may be solid and the electrolyte 204 may be excluded from the anode. In various embodiments the negative electrode 202 may be porous and the electrolyte 204 may be interspersed geometrically with the negative electrode 202, creating a greater interfacial surface area for reaction. In various embodiments, the air electrode 203 may be porous and the electrolyte interspersed geometrically with the negative electrode 203, creating a greater interfacial surface area for reaction. In various embodiments, the air electrode 203 may be positioned at the interface of the electrolyte and a gaseous headspace (not shown). In various embodiments, the gaseous headspace may be sealed in a housing. In various other embodiments, the housing may be unsealed and the gaseous headspace may be an open system which can freely exchange mass with the environment.

The negative electrode 202 may be formed from a metal or metal alloy, such as lithium (Li), sodium (Na), potassium (K), magnesium (Mg), calcium (Ca), silicon (Si), aluminum (Al), zinc (Zn), or iron (Fe); or alloys substantially comprised of one or more of the forgoing metallic elements, such as an aluminum alloy or iron alloy (e.g., FeAl, FeZn, FeMg, etc.) that can undergo an oxidation reaction for discharge. As such, the anode or negative electrode 202 may be referred to as the metal electrode herein.

In certain embodiments, the battery may be rechargeable and the metal electrode may undergo a reduction reaction when the battery is charged. The anode 202 may be a solid, including a dense or porous solid, or a mesh or foam, or a particle or collection of particles, or may be a slurry, ink, suspension, or paste deposited within the housing. In various embodiments, the anode 202 composition may be selected such that the anode 202 and the volume of liquid electrolyte 204 may not mix together. For example, the anode 202 may be a metal electrode that may be a bulk solid. As another example, the anode 202 may be a collection of particles, such as small or bulky particles, within a suspension that are not buoyant enough to escape the suspension into the electrolyte. As another example, the anode 202 may be formed from particles that are not buoyant in the electrolyte.

The air electrode 203 may support the reaction with oxygen on the positive electrode. The cathode 203 may be a so-called gas diffusion electrode (GDE) in which the cathode is a solid, and it sits at the interface of a gas headspace and the electrolyte 204. During the discharge process, the cathode 203 supports the reduction of oxygen from the gaseous headspace, the so-called Oxygen Reduction Reaction (ORR). In certain embodiments, the battery 200 is rechargeable and the reverse reaction occurs, in which cathode 203 supports the evolution of oxygen from the battery, the so-called Oxygen Evolution Reaction (OER). The OER and ORR reactions are commonly known to those skilled in the art.

In various embodiments the electrolyte 204 is a liquid. In certain embodiments, the electrolyte 204 may be an aqueous solution, a non-aqueous solution, or a combination thereof. In various embodiments the electrolyte 204 is an aqueous solution which may be acidic (low-pH), neutral (intermediate pH), or basic (high pH; also called alkaline or caustic). In certain embodiments the liquid electrolyte 204 may comprise an electropositive element, such as Li, K, Na, or combinations thereof. In some embodiments, the liquid electrolyte may be basic, namely with a pH greater than 7. In some embodiments the pH of the electrolyte is greater than 10, and in other embodiments, greater than 12. For example, the electrolyte 204 may comprise a 6M (mol/liter) concentration of potassium hydroxide (KOH). In certain embodiments, the electrolyte 204 may comprise a combination of ingredients such as 5.5M potassium hydroxide (KOH) and 0.5M lithium hydroxide (LiOH). In certain embodiments the electrolyte 140 may comprise a 6M (mol/liter) concentration of sodium hydroxide (NaOH). In certain embodiments the electrolyte 140 may comprise a 5M (mol/liter) concentration of sodium hydroxide (NaOH) and 1M potassium hydroxide (KOH).

In certain embodiments, the battery 200 (e.g., metal-air battery) discharges by reducing oxygen (O₂) typically sourced from air. This requires a triple-phase contact between gaseous oxygen, an electronically active conductor which supplies the electrons for the reduction reaction, and an electrolyte 140 which contains the product of the reduction step. For example, in certain embodiments involving an aqueous alkaline electrolyte, oxygen from air is reduced to hydroxide ions through the half-reaction O₂+2H₂O+4e⁻→4OH⁻. Thus, oxygen delivery to metal-air cells requires gas handling and maintenance of triple-phase points. In certain embodiments, called “normal air-breathing” configurations, the cathode 203 may be mechanically positioned at the gas-liquid interface to promote and maintain triple-phase boundaries. The cathode 203 may be positioned vertically or horizontally, or at any intermediate angle with respect to gravity, and maintain a “normal air-breathing” configuration. In these “normal air-breathing” configurations, the gas phase is at atmospheric pressure (i.e. it is unpressurized beyond the action of gravity).

The configuration of the electrochemical cell (or battery 200) in FIG. 3 is merely an example of one electrochemical cell configuration according to various embodiments and is not intended to be limiting. Other configurations, such as electrochemical cells with different type vessels and/or without the vessel 201, electrochemical cells with different type air electrodes and/or without the air electrode 203, electrochemical cells with different type current collectors and/or without the current collector 206, electrochemical cells with different type negative electrodes and/or without the negative electrode 202, and/or electrochemical cells with different type electrolytes and/or electrochemical cells without liquid electrolyte 204 may be substituted for the example configuration of the battery 200 shown in FIG. 3 and other configurations are in accordance with the various embodiments.

In various embodiments, the vessel 201 may be made from a polymer such as polyethylene, acrylonitrile butadiene styrene (ABS), high-density polyethylene (HDPE), ultra-high molecular weight polyethylene (UHMW), polypropylene, and/or other polymers. In certain embodiments the vessel 201 and/or housing for the electrochemical cell 200 may be made from a metal such as nickel, steel, anodized aluminum, nickel coated steel, nickel coated aluminum or other metal.

In various embodiments, a battery (e.g., battery 200) may include three electrodes—an anode (e.g., 202) and a dual cathode (e.g., cathode 203 constituted in two parts, such as a first cathode, and a second cathode). The electrodes may have finite useful lifetimes, and may be mechanically replaceable. For example, the anode may be replaced seasonally. The first cathode may be divided into two portions, a first portion having a hydrophilic surface and a second portion having a hydrophobic surface. For example, the hydrophobic surface may have a polytetrafluorethylene (PTFE) (e.g., Teflon®) hydrophobic surface.

For example, the second portion may be a microporous layer (MPL) of polytetrafluorethylene (PTFE) and high surface area carbon while the first portion may be carbon fiber partially coated with PTFE. As another example, the second portion may be a MPL of PTFE and carbon black and the first portion may be PTFE of approximately 33% by weight. As a further example, the second portion may be an MPL of 23% by weight PTFE and 77% by weight carbon black and the first portion may be a low loading MPL. The anode may be an iron (Fe) electrode or an iron-alloy (Fe-alloy) electrode (e.g., FeAl, FeZn, FeMg, etc.). The second cathode may have a hydrophilic surface. The second cathode may have a metal substrate, such as carbon (C), titanium (Ti), steel, etc., coated with nickel (Ni). Electrolyte (e.g., electrolyte 140) may be disposed between the three electrodes. The electrolyte may be infiltrated into one or more of the three electrodes.

Battery systems may be comprised of a number of cells connected in series and/or parallel in a shared electrolyte bath, and contained in a housing.

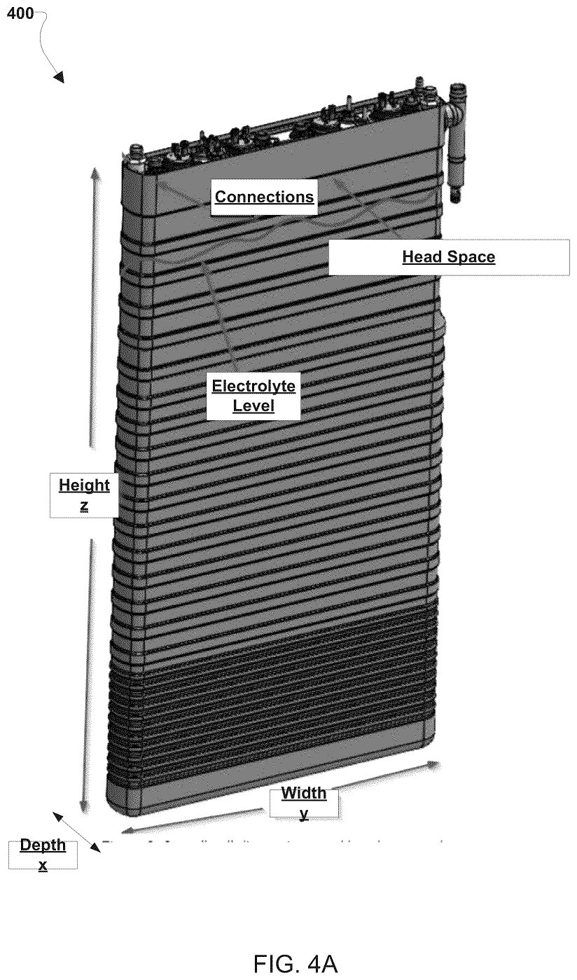

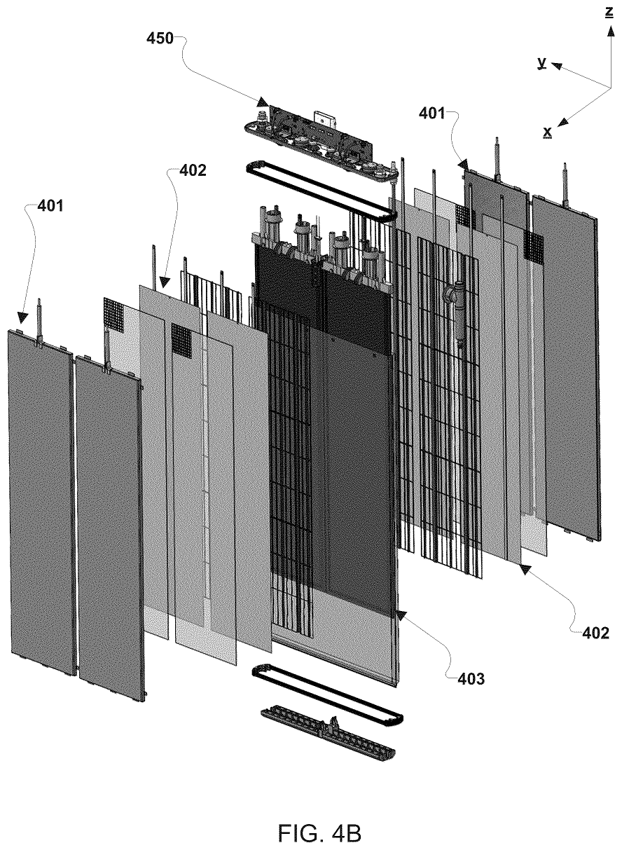

FIG. 4A is a schematic diagram of an example single electrochemical cell (or battery) enclosure 400 in accordance with various embodiments. With reference to FIGS. 1-4A, the enclosure 400 may include a battery, such as battery 200, in accordance with various embodiments. In some implementations, the enclosure 400 may be the vessel, such as vessel 201, in which an air electrode (e.g., a cathode), such as air electrode 203, a negative electrode (e.g., an anode), such as negative electrode 202, and an electrolyte, such as electrolyte 204, are disposed. The electrolyte, such as electrolyte 204, may rise to a given level within the enclosure 400 and a headspace between the top of the enclosure 400 and electrolyte level may be formed in the enclosure 400. The enclosure 400 may have a height (e.g., a z dimension), a width (e.g., a y dimension), and a depth (e.g., a x dimension). In one example, configuration, the height may be greater than the width and depth and the width may be greater than the depth such that the enclosure 400 is a generally rectangular cuboid. The enclosure 400 may include one or more various connections, such as electrical connections, electrolyte connections, gas connections (e.g., air connections), vents, etc. Via the connections, two or more electrochemical cells (or batteries) may be connected together, such as in series and/or in parallel, to form a module.

Each cell/battery enclosure, such as enclosure 400, in a module may be a self-contained unit supporting its own respective air electrode (e.g., air electrode 203), negative electrode (e.g., negative electrode 202), and electrolyte (e.g., electrolyte 204) volume. The module structure may support the cell enclosures, such as enclosures 400, disposed within the module.

FIG. 4B is an exploded view diagram of portions of an inside of the example electrochemical cell (or battery) enclosure 400 showing one example configuration of an electrochemical cell (or battery) in accordance with various embodiments. With reference to FIGS. 1-4B, the enclosure 400 may have within it various electrochemical cell (or battery) elements including one or more anode assemblies 401, such as one or more negative electrodes 202, one or more cathode assemblies, such as a cathode 203, and electrolyte, such as electrolyte 204. The configuration in FIG. 4B illustrates a two part cathode in which the cathode assembly includes an Oxygen Evolution Electrode (OEE) 402 and a separate gas diffusion electrode (GDE) 403. A battery configuration may include at least one OEE 402 and at least one GDE 403 may be referred to as a multi-cathode battery cell. The OEE 402 may be disposed within the enclosure between an anode assembly 401 and the GDE 403. The GDE 403 may be disposed in the center of the enclosure 400 and an additional GDE 403 and anode assembly 401 pair may be in a minor configuration on the opposite side of the GDE 403. Air may enter the enclosure 400 and pass into the center of the GDE 403. Thus, in an example configuration, each electrochemical cell (or battery) enclosure 400 may include opposite side anode assemblies 401 each with their own respective OEE 402 in board of the respective anode assemblies 401, with a central GDE 403 with air passage down the center between the two OEEs 402. However, such internal cell (or battery) structure is merely one example configuration of the cell (or battery) that may be within an example enclosure, such as enclosure 400, and is not intended to be limiting. Additionally, the enclosure 400 may include one or more cell electronics structures 450, such as a printed circuit board assembly (PCB A), circuitry housing, etc., supporting various electronic devices, such as controllers, sensors, switches, wiring buses, etc., that may control and/or manage operations of the multi-cathode battery cell.

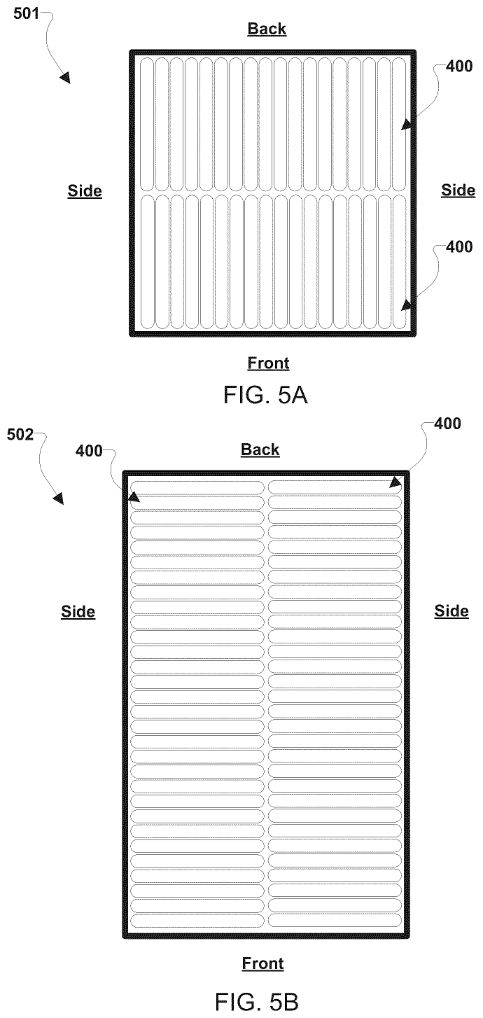

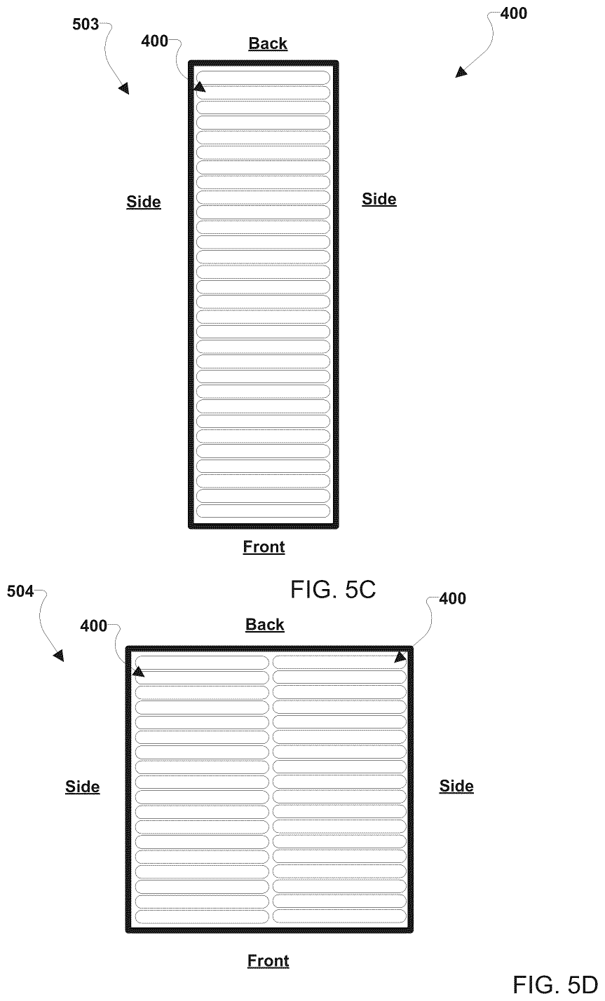

FIG. 5A is a schematic diagram of an example module 501 configuration including multiple electrochemical cell enclosures 400 in accordance with various embodiments. With reference to FIGS. 1-5A, the module 501 is shown from an overhead view looking down the height (e.g., z dimension) of the cell enclosures 400. The module 501 configuration may be a generally cubic configuration with the front, back, and sides of the module 501 about the same lengths. In the module 501, two rows of cell enclosures 400 may be arranged such that the widths of the cell enclosures 400 run parallel to the sides of the module 501 and the depths of the cell enclosures 400 run parallel to the front and back of the module 501. In the configuration of the module 501, the widths of the two cell enclosures 400 may generally govern the length of the sides of the module 501 along with any spacing between the rows of enclosures 400 and spacing of the respective rows and the front and back of the module 501. The number enclosures 400 in each row and the depth of the enclosures 400 may generally govern the length of the front and back of the module 501 along with the spacing between the enclosures 400 in each row and the spacing of the respective rows and the sides of the module 501.

FIG. 5B is a schematic diagram of another example module 502 configuration including multiple electrochemical cell enclosures 400 in accordance with various embodiments. With reference to FIGS. 1-5B, the module 502 is shown from an overhead view looking down the height (e.g., z dimension) of the cell enclosures 400. The module 502 configuration may be a generally rectangular configuration with the sides of the module 502 longer than the back and front of the module 502. In the module 502, two rows of cell enclosures 400 may be arranged such that the widths of the cell enclosures 400 run parallel to the front and back of the module 502 and the depths of the cell enclosures 400 run parallel to the sides of the module 502. In the configuration of the module 502, the widths of the two cell enclosures 400 may generally govern the length of the front and back of the module 502 along with any spacing between the rows of enclosures 400 and spacing of the respective rows and the sides of the module 502. The number enclosures 400 in each row and the depth of the enclosures 400 may generally govern the length of the sides of the module 502 along with the spacing between the enclosures 400 in each row and the spacing of the respective rows and the front and back of the module 502.

FIG. 5C is a schematic diagram of another example module 503 configuration including multiple electrochemical cell enclosures 400 in accordance with various embodiments. With reference to FIGS. 1-5C, the module 503 is shown from an overhead view looking down the height (e.g., z dimension) of the cell enclosures 400. The module 503 configuration may be a generally rectangular configuration with the sides of the module 503 longer than the back and front of the module 503. In the module 503, a single row of cell enclosures 400 may be arranged such that the widths of the cell enclosures 400 run parallel to the front and back of the module 503 and the depths of the cell enclosures 400 run parallel to the sides of the module 502. In the configuration of the module 503, the widths of the single row of cell enclosures 400 may generally govern the length of the front and back of the module 503 along with any spacing between the sides of the module 503. The number enclosures 400 in the row and the depth of the enclosures 400 may generally govern the length of the sides of the module 503 along with the spacing between the enclosures 400 in the row and the spacing between the front and back of the module 503.

FIG. 5D is a schematic diagram of another example module 504 configuration including multiple electrochemical cell enclosures 400 in accordance with various embodiments. With reference to FIGS. 1-5D, the module 504 is shown from an overhead view looking down the height (e.g., z dimension) of the cell enclosures 400. The module 504 configuration may be a generally cubic configuration with the front, back, and sides of the module 501 about the same lengths. In the module 504, two rows of cell enclosures 400 may be arranged such that the widths of the cell enclosures 400 run parallel to the front and back of the module 504 and the depths of the cell enclosures 400 run parallel to the sides of the module 502. In the configuration of the module 504, the widths of the two cell enclosures 400 may generally govern the length of the front and back of the module 504 along with any spacing between the rows of enclosures 400 and spacing of the respective rows and the sides of the module 504. The number enclosures 400 in each row and the depth of the enclosures 400 may generally govern the length of the sides of the module 504 along with the spacing between the enclosures 400 in each row and the spacing of the respective rows and the front and back of the module 504.

The configuration of the modules 501-504 in FIGS. 5A-5D are merely examples modules including multiple electrochemical cell configurations according to various embodiments and are not intended to be limiting. Other configurations, such modules with more or less rows, modules with no-linear configurations, modules with more or less cells, etc., may be substituted for the example configuration of the modules 501-504 and other configurations are in accordance with the various embodiments.

In various embodiments, battery modules having strings of cells therein, such as modules 501-504, may be enclosed in a module enclosure. A module enclosure may house one or more modules, modules having strings of cells therein, such as modules 501-504.

Modules, such as modules 501-504, deployed in the field may need protection from the elements, such as: wind, dust, snow, rain, seismic activity, etc. The modules, such as modules 501-504, may also need to be secured to the ground to prevent movement in the event of heavy winds and/or seismic activity. Personnel also need to have protections from high voltage, caustic fluids, and any other hazardous conditions associated with the operation of a battery system. There are several auxiliary systems that will also need support for operating the battery energy storage system, including secondary containment, thermal management, hydrogen management, gas diffusion electrode (GDE) support, air supply, electrolyte/water management, etc. Enclosures may be configured in accordance with various embodiments, to provide such support to one or more modules, such as modules 501-504, in a battery system.

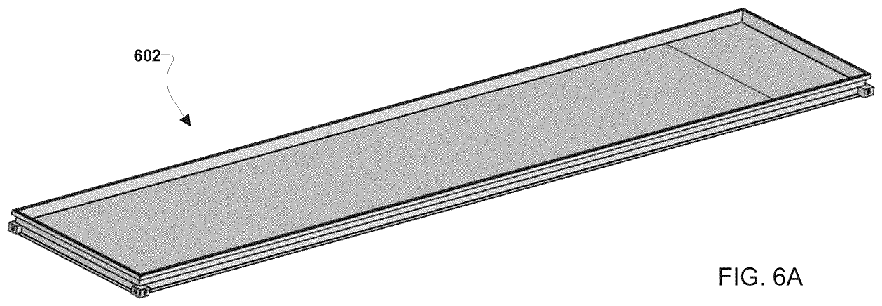

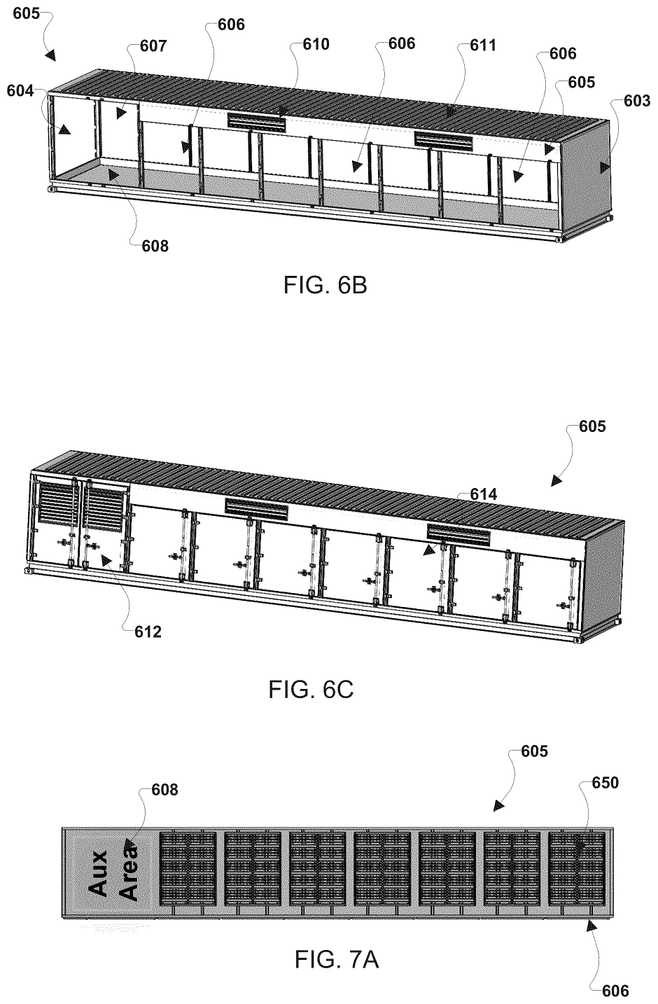

FIGS. 6A-6C illustrate portions of an example enclosure 605 for one or more modules, such as modules 501-504, in a battery system. With reference to FIGS. 1-6C, FIG. 6A illustrates a lower structure 602 of the enclosure 605, FIG. 6B illustrates the enclosure 605 with doors 612 and 614 removed, and FIG. 6C illustrates the enclosure 605 with the doors 612 and 614 installed. Additionally, other doors and/or hatches may be installed along other walls and/or the roof of the enclosure 605. In various embodiments, the lower structure 602 may support the entire weight of the battery modules for transport and installation. A secondary containment may be fabricated into the lower structure 602, for example to handle both the potential for a spill and fire water if it is incorporated in the design. Lifting points will be provided in the lower structure 602 as it can be lifted either by the corners or have additional pick points incorporated along its length. The base of the lower structure 602 may include attachment points to secure the battery modules, such as modules 501-504, to the enclosure 605, for example to support shipping, seismic event dampening, etc. In various embodiments, the enclosure 605 may include any number of modules, such as modules 501-504 therein. The configuration of the enclosure 605 illustrated in FIGS. 6A-6C shows a configuration for at least seven modules, such as modules 501-504, but more or less modules may be present in the enclosure depending on enclosure size and/or configuration. The enclosure 605 may include mounting points provided to attach to a variety of field installation structures, such as grade beams, piles, helical piers, foundations, etc., upon deployment in the field.

In some embodiments, the enclosure may include an auxiliary area 608. In some embodiments, the auxiliary area 608 may be located at one end of the enclosure in which auxiliary equipment to support the modules, such as modules 501-504, may be mounted. In other embodiments, the auxiliary area 608 may be located anywhere along the enclosure, such as in the middle of the enclosure, in a first third of the enclosure, etc., and the modules, such as modules 501-504 may be located on either side of the auxiliary area. Auxiliary equipment may include, pumps, blowers, controllers, switches, connections, tubing, ducting, heaters, chillers, filters, reservoirs, tanks, electronics, or any other type equipment that may support the operation of the modules, such as modules 501-504, within the enclosure 605. The support subsystems may be housed in the auxiliary area 608 and connected to the modules, such as modules 501-504. The support subsystems may include GDE air systems, thermal management systems, hydrogen management systems, water and/or electrolyte management systems, power electronics systems, controls electronics systems, communications systems, telemetry sensors and equipment, and/or disconnects from plant level services, as well as any other type subsystems.

The floor of the enclosure 605 may also have perforations to allow for stub ups of electrical, water, or any other desired connection to be made upon installation in the field as long as the perforation is properly designed to maintain the secondary containment requirements of the lower structure.

As illustrated in FIGS. 6B and 6C, walls 603, 604, 605, and 607 may be attached to the lower structural base 602, and designed to support any snow loads taken up by the roof 611, as well being designed to handle wind loads. This structural shell may also provide a for mounting any of the auxiliary subsystems that need to be run throughout the enclosure 605. While illustrated as metal walls 603, 604, 605, and 607 and roof 611, all or portions of the walls and/or roof may be formed from other materials, such as fabric, cloth, etc. In various configurations, the enclosure may be formed into different areas, such as the auxiliary area 608 and module bays 606. In various embodiments, the auxiliary area 608 may be covered by a door 612 on one or both long sides of the enclosure 605 and module bays 606 may be covered by doors 614 on one or both long sides of the enclosure 605. The doors 612 and/or 614 may enable access to the auxiliary equipment and/or modules for servicing and/or replacement. In some embodiments, perforations 610 may be present in the side walls 605 and/or roof 611 to allow for air to be exchanged from ambient to the enclosure 605 and vice versa. Filter grates may be one example of the perforations 610. The configuration of the enclosure 605 may maintain low dust intrusion and/or protect against driven rain.

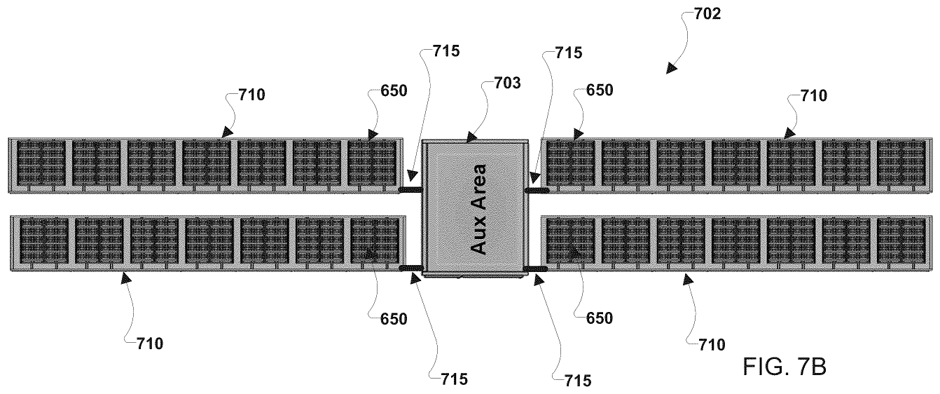

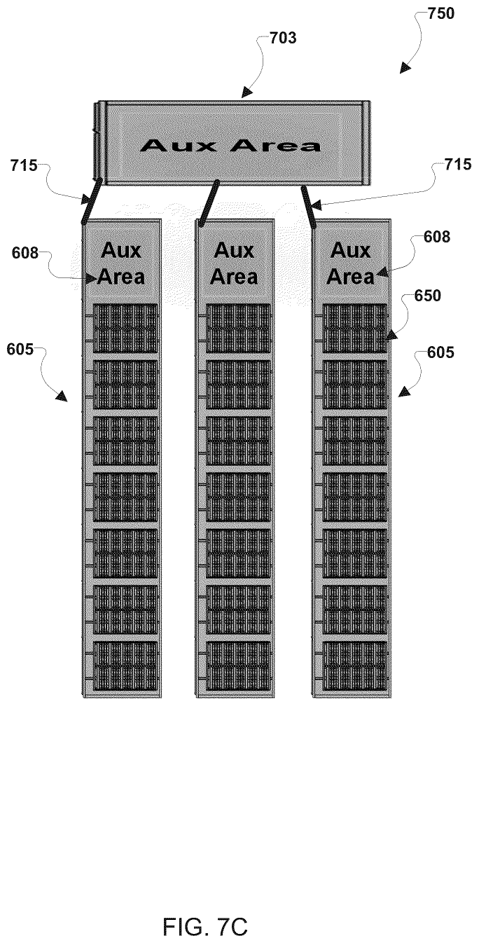

FIGS. 7A-7C illustrate battery module enclosure configurations in accordance with various embodiments. With reference to FIGS. 1-7C, FIG. 7A illustrates a top down view of example enclosure 605 in which the auxiliary area 608 is within the enclosure 605 and co-located with the modules 650, such as modules 501-504, within the module bays 606. While seven sets of modules are illustrated in FIG. 7A, this is merely one example, and more or less modules may be present in the enclosure 605.

FIG. 7B illustrates an alternative configuration 702 in which the enclosures 710 supporting the modules 650, such as modules 501-504, may not include auxiliary areas therein, and rather a central auxiliary area 703 may support one or more enclosures 710. This separate auxiliary area 703 enclosure may be connected to the modules by one or more connections 715 and the auxiliary area 703 may feed the subsystem services, such as those of GDE air systems, thermal management systems, hydrogen management systems, water and/or electrolyte management systems, power electronics systems, controls electronics systems, telemetry sensors and equipment, and/or disconnects from plant level services, as well as any other type subsystems, to the enclosures 710 and the modules 650 therein. While four enclosures 710 are illustrated in FIG. 7B, more or less enclosures 710 may be connected to the auxiliary area 703 and the auxiliary area 703 may be sized according to the number of enclosures to support and number of modules within the enclosures.

FIG. 7C illustrates an alternative configuration 750 in which a separate auxiliary area 703 enclosure is connected to the enclosures 605 which also have auxiliary areas 608 therein. In this manner, some auxiliary system functions may be in whole, or in part, offloaded to the separate auxiliary area 608 and some auxiliary system functions may in whole, or in part, remain at the enclosure 605 level.

While FIGS. 7A-7C illustrate various configurations for enclosures and/or auxiliary areas, the configurations illustrated in FIGS. 7A-7C are merely examples according to various embodiments and are not intended to be limiting. Other configurations of enclosures and/or auxiliary areas may be substituted for the example configuration of FIGS. 7A-7C and other configurations are in accordance with the various embodiments.

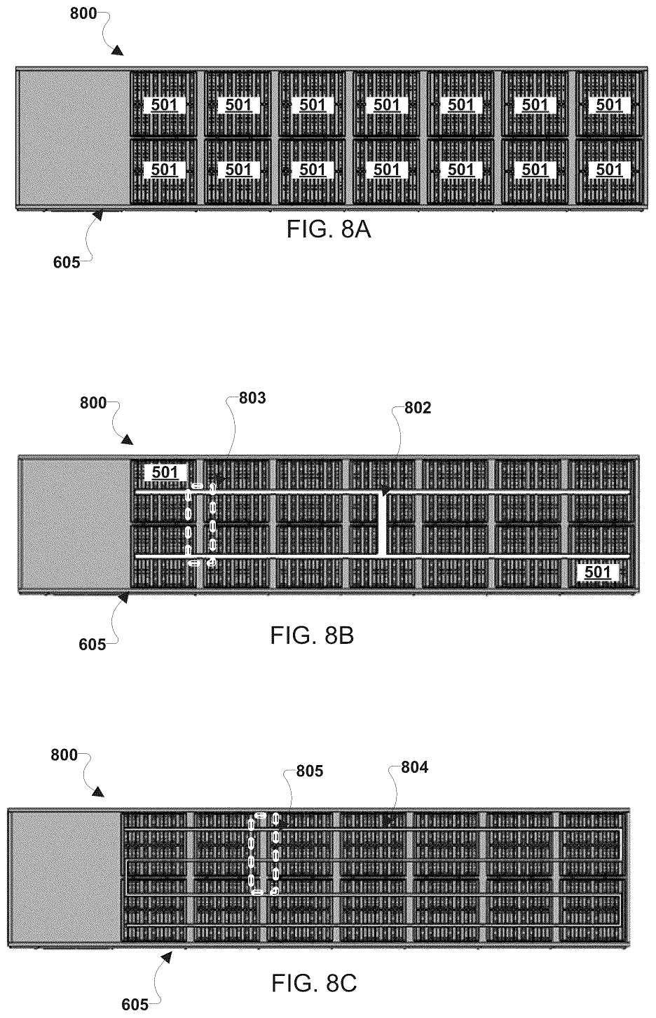

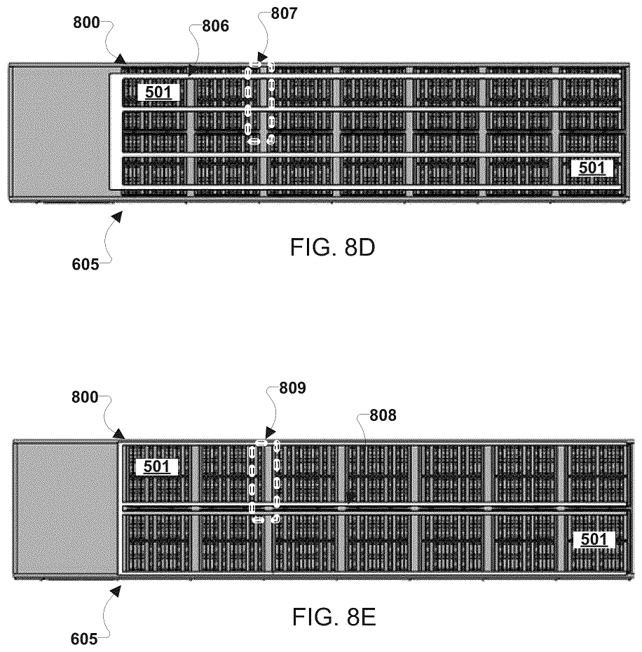

FIGS. 8A-8E illustrate an example module 501 layout 800 within an enclosure 605 in accordance with various embodiments. With reference to FIGS. 1-8E, FIGS. 8A-8E illustrate a layout 800 in which two modules 501 are arranged front to back within a module bay. In the layout 800, electrical routing may be provided and all hookups may be on the enclosure 605 short end. In the layout 800, space may be required within the enclosure 605 for module removal. In the layout 800, electrode width may be tied to the smallest enclosure 605 dimension. In the layout 800, thermal spacing may be tied to the smallest enclosure dimension. Layout 800 may require connection and/or disconnection of a back module 501 of the two modules 501 in each module bay. Layout 800 may require some activities of personnel to be performed in the enclosure.

FIG. 8B illustrates an example thermal management ducting/plumbing system configuration 803 and connections 804 needed to be made inside the enclosure 605 to install and/or remove a module 501. FIG. 8C illustrates an example electrical system connection configuration 804 and connections 805 needed to be made inside the enclosure 605 to install and/or remove a module 501. FIG. 8D illustrates an example GDE air system connection configuration 806 and connections 807 needed to be made inside the enclosure 605 to install and/or remove a module 501. FIG. 8E illustrates an example water and/or electrolyte system connection configuration 808 and connections 809 needed to be made inside the enclosure 605 to install and/or remove a module 501.

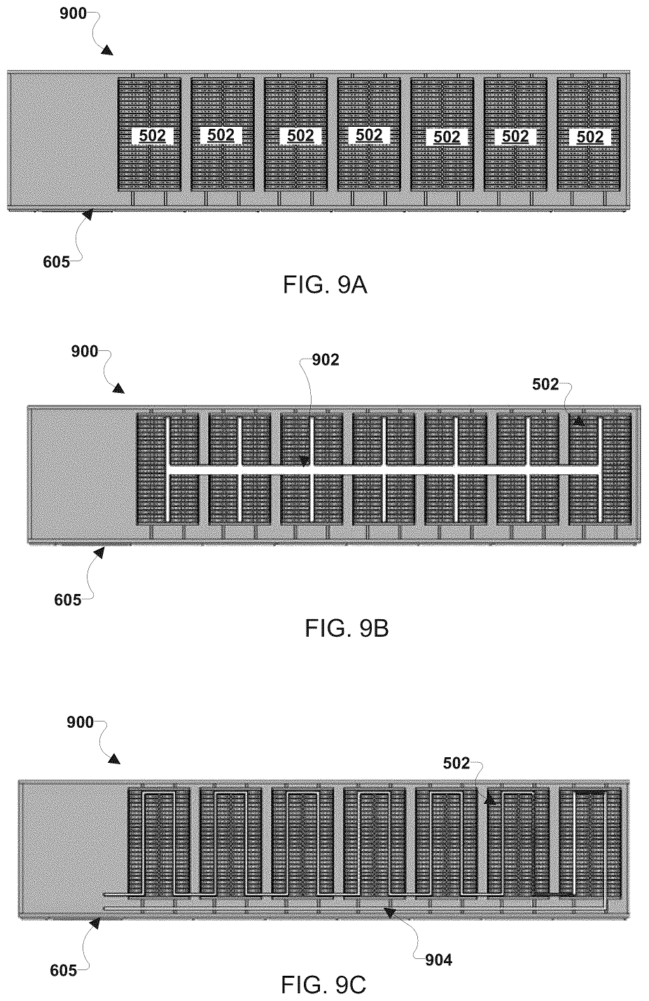

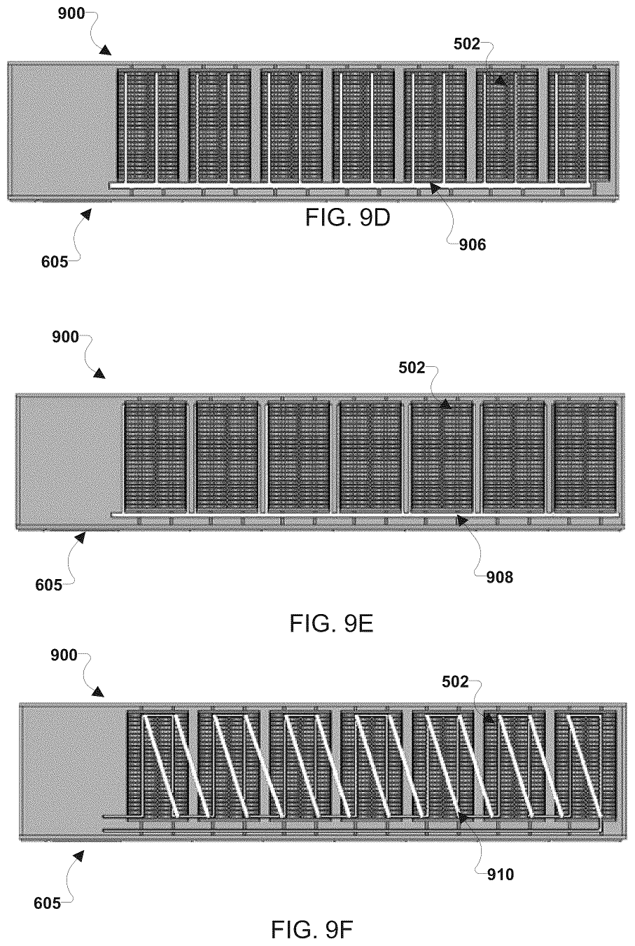

FIGS. 9A-9F illustrate an example module layout 900 within an enclosure 605 in accordance with various embodiments. With reference to FIGS. 1-9F, FIGS. 9A-9F illustrate a layout 900 in which a module 502 may be arranged within each module bay. In the layout 900, the module connections may be at the doors of the module bays.

FIG. 9B illustrates an example thermal management ducting/plumbing system configuration 902 inside the enclosure 605. FIG. 9C illustrates an example electrical system connection configuration 904 inside the enclosure 605. FIG. 9D illustrates an example GDE air system connection configuration 906 inside the enclosure 605. FIG. 9E illustrates an example water and/or electrolyte system connection configuration 908 inside the enclosure 605. FIG. 9F illustrates an optional second electrical system connection configuration 910 (shown in white) including blind mating at the back of the modules 502 and front side connections.

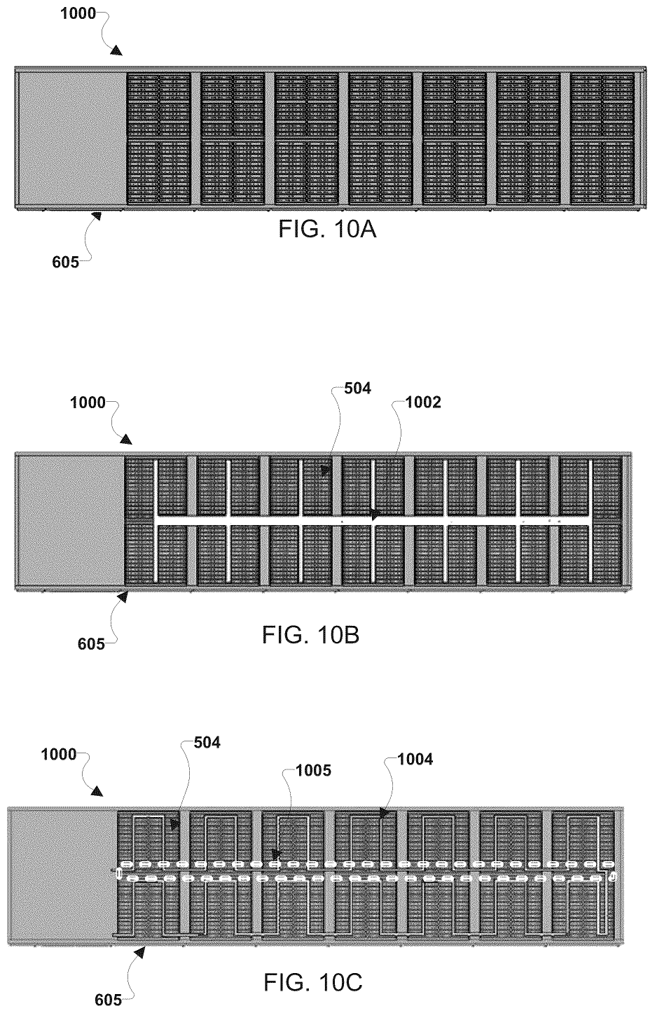

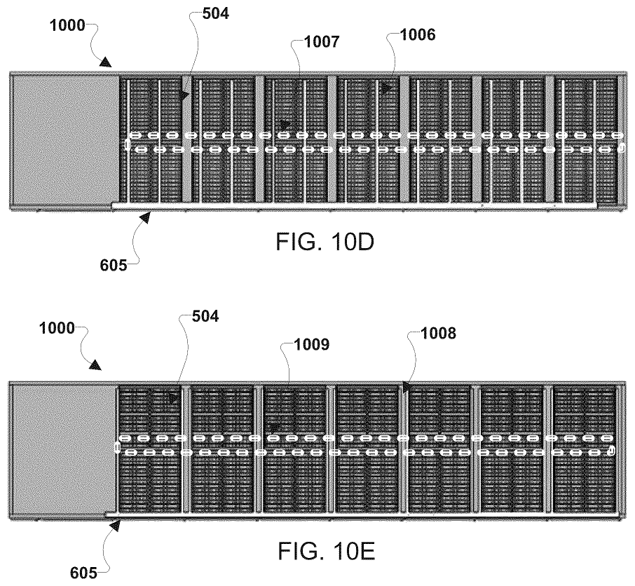

FIGS. 10A-10E illustrate an example module 504 layout 1000 within an enclosure 605 in accordance with various embodiments. With reference to FIGS. 1-10E, FIGS. 10A-10E illustrate a layout 1000 in which two modules 504 are arranged front to back within a module bay. In the layout 1000, space may be required within the enclosure 605 for module removal. In the layout 1000, electrode width may independent of enclosure 605 width. Layout 1000 may require connection and/or disconnection of a back module 504 of the two modules 504 in each module bay. Layout 1000 may require some activities of personnel to be performed in the enclosure.

FIG. 10B illustrates an example thermal management ducting/plumbing system configuration 1003 inside the enclosure 605. FIG. 10C illustrates an example electrical system connection configuration 1004 and connections 1005 needed to be made inside the enclosure 605 to install and/or remove a module 504. FIG. 10D illustrates an example GDE air system connection configuration 1006 and connections 1007 needed to be made inside the enclosure 605 to install and/or remove a module 504. FIG. 10E illustrates an example water and/or electrolyte system connection configuration 1008 and connections 1009 needed to be made inside the enclosure 605 to install and/or remove a module 504.

While FIGS. 8A-10E illustrate various configurations for enclosures and modules within those enclosures, the configurations illustrated in FIGS. 8A-10E are merely examples according to various embodiments and are not intended to be limiting. Other configurations for enclosures and modules within those enclosures may be substituted for the example configuration of FIGS. 8A-10E and other configurations are in accordance with the various embodiments. Additionally, while FIGS. 8A-10E illustrate example module layouts 800, 900, and 1000 showing an auxiliary area 608 within the enclosure, the configurations of the thermal management ducting/plumbing systems configurations and connections, electrical systems connection configurations and connections, GDE air systems configurations and connections, and/or water and/or electrolyte system configurations and connections may be similar configurations in which no auxiliary area is within the enclosures, such as configuration 702, and/or configurations in which the auxiliary area 608 is located within the central area of the enclosure between modules, such as between any two modules 501-504.

Operating without proper cooling across all cells of the modules within an enclosure can have several deleterious effects. In particular, battery cell performance varies with temperature. Therefore, normal variances within a module or set of modules may lead to different rates of charge or discharge, and require extra controls or algorithm adjustments to manage these differences.

A battery cell that is not receiving proper cooling can exceed a maximum temperature, and may cause the cell, module, or enclosure to shut down. Further, cells operating at different temperatures will typically have different degradation rates, which may lead to premature retirement of a cell or module including the cell. Additionally, battery cells operating at different temperatures have different self-discharge rates, which could lead to improperly balanced cells within a module or enclosure.

Therefore, various systems may provide thermal management of the plurality of modules of battery cells within an enclosure using cooled and/or heated airflow and/or liquid.

Embodiment systems may include a filter through which ambient air enters the space of an enclosure that houses multiple battery modules. Some embodiments may include ducting that connects adjacent modules and leads outside the enclosure. The modules may pull conditioned air from the enclosure to cool the battery cells, and to exhaust hot air through the ducting. In some embodiments, cooling may be accomplished by moving air through cooling channels on the surface of the cells within each module. In various embodiments, the system may include at least one air mover (e.g., one or more fan) to move air through the cooling channels and/or out of the enclosure using pressure and/or vacuum. For example, one or more fan may be placed at the inlet of the enclosure (e.g., after the filter).

In another example, one or more exhaust blower may be placed at an outlet to the enclosure. In various embodiments, the at least one air mover may comprise a plurality of fans in order to provide redundancy in case of failure. In some embodiments, the air mover(s) may serve to cycle the air in the enclosure, as well as to vent noxious gases from the enclosure.

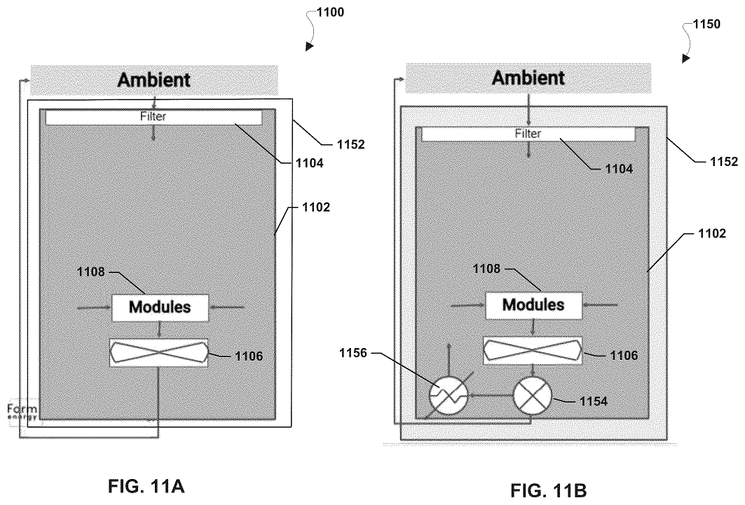

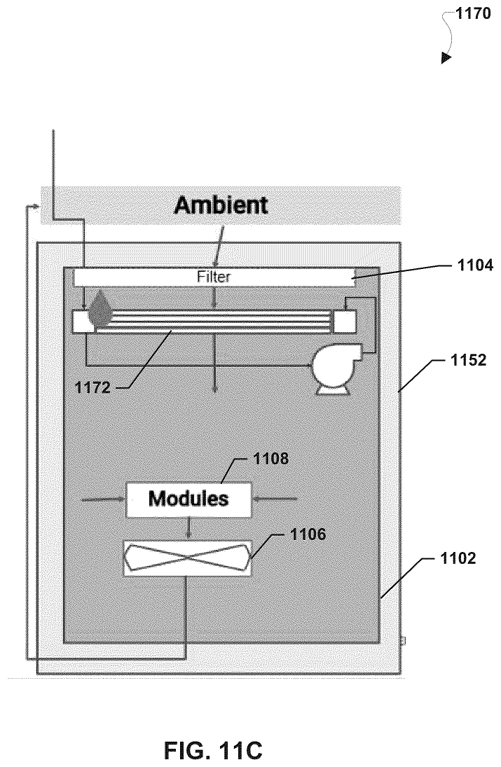

FIGS. 11A-11C illustrate example thermal management systems in accordance with various embodiments. With reference to FIGS. 1-11C, FIG. 11A shows system 1100 that includes an enclosure 1102, which may be similar to enclosures previously described (e.g., 605, 710, etc.). System 1100 may also include a filter 1104 for air entering the enclosure, an air mover 1106 (e.g., a centrifugal blower), and a plurality of modules 1108 housed in the enclosure 1102. For example, the air mover 1106 may be housed in the auxiliary area 608. While illustrated as within the enclosure, the air mover 1106 may be located outside the enclosure, such as in auxiliary area 703. The modules 1108, which may be similar to the modules described in other embodiments (e.g., 501, 502, 503, 504, 650, etc.), pull in conditioned air from the enclosure 1102 to cool the battery cells (e.g., metal-air battery cells). The air mover 1106 in system 1102 may be positioned at an outlet to move air exhausted from the modules 1108.

In some embodiments, the thermal management system may also include a recirculation heating path to condition the air when working below a threshold temperature (e.g., less than 10 degrees Celsius). In such embodiments, a recirculation valve may be used to move air through a heater (e.g., an air heating coil), and the heated air may be circulated in the enclosure to be drawn in by the modules in the same manner for cooling. The system 1100 may optionally include insulation 1152 surrounding the outside of the enclosure 1102.

FIG. 11B illustrates an alternative thermal management system 1150 designed to accommodate operation in cold weather (e.g., below a threshold temperature). Specifically, system 1150 may include insulation 1152 surrounding the outside of the enclosure 1102. In some embodiments, the enclosure 1102 may include a recirculation path valve, such as a three-way valve 1154, and a heater 1156. In various embodiments, air from the modules 1108 and, optionally, the air mover 1110, may be exhausted outside the enclosure 1150, or may be circulated to the heater 1156, using the three-way valve 1154.

In some embodiments, the thermal management system may also include an evaporative cooler to condition the air that cycles within the enclosure, particularly when working above a threshold temperature (e.g., above 40 degrees Celsius). In such embodiments, an evaporative cooler may be positioned at the inlet of a duct leading within the enclosure, either before or after the filter, and may chill the air for circulation to be drawn in by the modules.

In some embodiments, one or more air mover (e.g., fan) placed at the inlet may be positioned either before or after the evaporative cooler. For example, FIG. 11C illustrates an alternative thermal management system 1170 designed to accommodate operation in hot weather (e.g., above a threshold temperature). Specifically, system 1170 may include insulation 1152, and an evaporative cooler 1172 positioned after the filter 1104.

Embodiment thermal management system may alternatively include a heating, ventilation, and air conditioning (HVAC) unit to condition the air that cycles within an enclosure housing a plurality of battery cell modules. In various embodiments, chilled air may be pumped into the enclosure and travel through cooling channels on the surface of the cells within each module. In various embodiments, the HVAC unit may include a compressor, a condenser, an evaporator, an air mover (e.g., at least one fan), and a refrigerant expansion device. The refrigerant expansion device may be, for example, a thermal expansion valve, electronic expansion valve, or sized orifice.

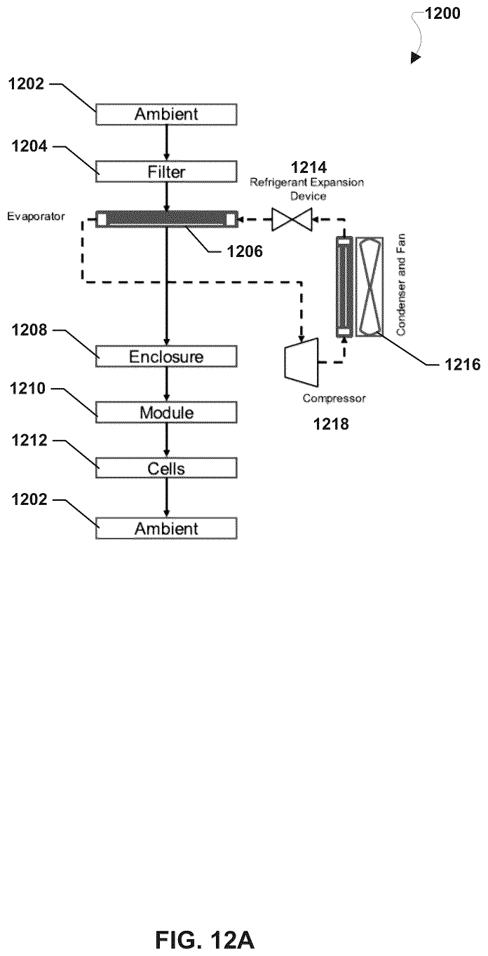

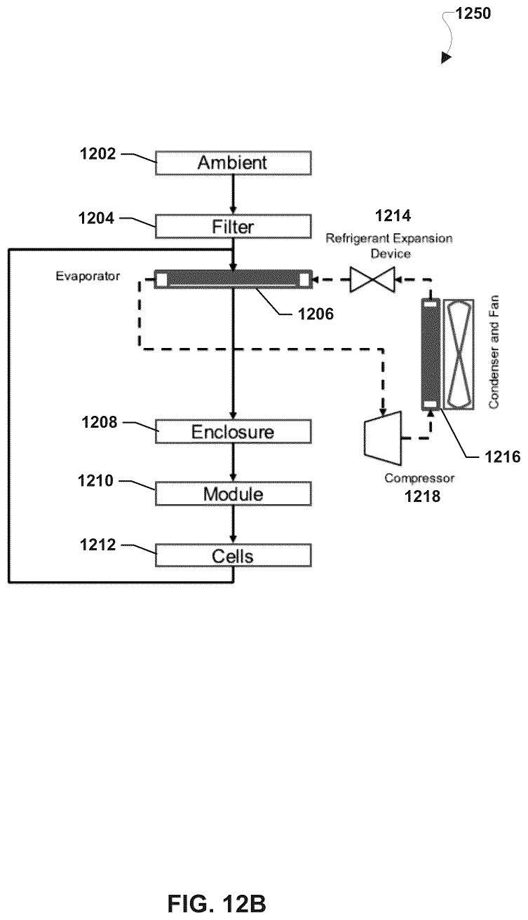

FIGS. 12A and 12B illustrate airflow in embodiment thermal management systems that use air cooled by refrigeration. With reference to FIGS. 1-12B, FIG. 12A shows the airflow pathway in a closed-loop thermal management system 1200. In system 1200, airflow may start with ambient air 1202, and go through a filter 1204 and an evaporator 1206 of an HVAC unit.

Air that is chilled by the evaporator unit 1206 may be passed into the enclosure 1208 (e.g., enclosure 605, 710, etc.), and drawn in by the modules 1210 (e.g., modules 501, 502, 503, 504, 650, etc.) for use in cooling the constituent cells 1212 (e.g., cells within cell enclosures 400). In the closed-loop system 1200, the air that is exhausted from the module(s) 1210/battery cells 1212 is recirculated in order to keep debris out of the enclosure 1208. However, as shown in FIG. 12B, the air that is exhausted from the module(s) 1210/battery cells 1212 in the open-loop system 1250 may be released outside of the enclosure.

In addition to the evaporator 1206, the HVAC unit in the thermal management systems 1200, 1250 may include other components for chilling air, such as a compressor 1218, a condenser 1216, at least one air mover (e.g., fan), and a refrigerant expansion device 1214. The refrigerant expansion device 1214 may be, for example, a thermal expansion valve, an electronic expansion valve, or a sized orifice for refrigerant. In various embodiments, refrigerant may cycle in a pathway between various components of the HVAC unit. The various components of the HVAC unit, such as the filter 1204, evaporator 1206, expansion device 1214, and/or condenser and fan 1216, may be located in an auxiliary area, such as auxiliary area 608, 703, and/or distributed across multiple auxiliary areas, such as partially in auxiliary area 608 and partially in auxiliary area 703.

Embodiment thermal management system may alternatively include a liquid cooling unit and liquid heating unit to control the temperature of the cells within the plurality of modules in an enclosure. In various embodiments, a set of cooling channels may be included on the surface of the cells (e.g., cell cold plates) through which cool or hot liquid may be moved to condition each individual cell. In various embodiments, at least one liquid mover (e.g., a pump) may be included, which may move the liquid from the cells to a cooling unit outside the enclosure for heat rejection.

Following heat rejection, the liquid may be moved to a liquid heating unit to optionally warm up the cell if needed based on the operating temperature. For example, the liquid heating unit may be a water immersion heater. In some embodiments, the liquid heating unit may be positioned inside the enclosure, while in other embodiments the liquid heating unit may be outside the enclosure.

The liquid cooling unit in some embodiments may be, for example, a radiator and fan, a cooling tower, a refrigeration circuit, or any of a number of other devices.

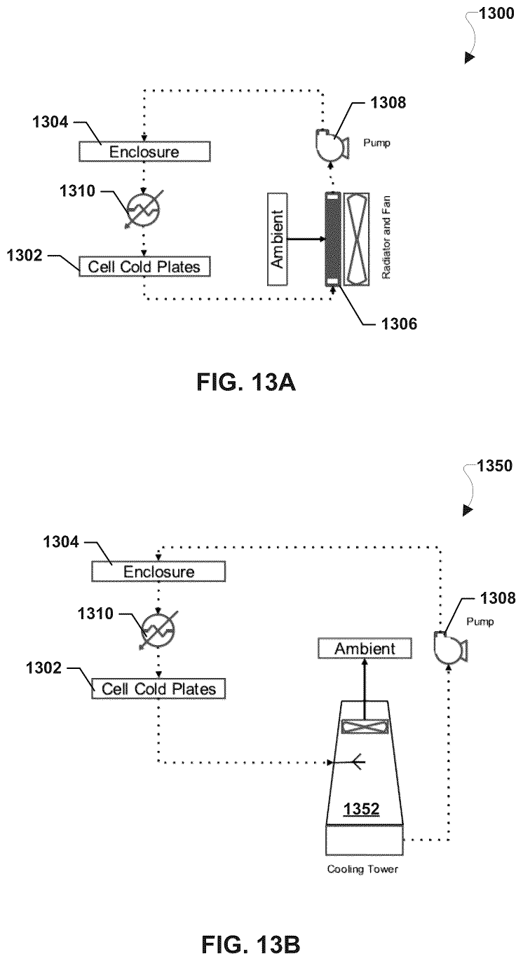

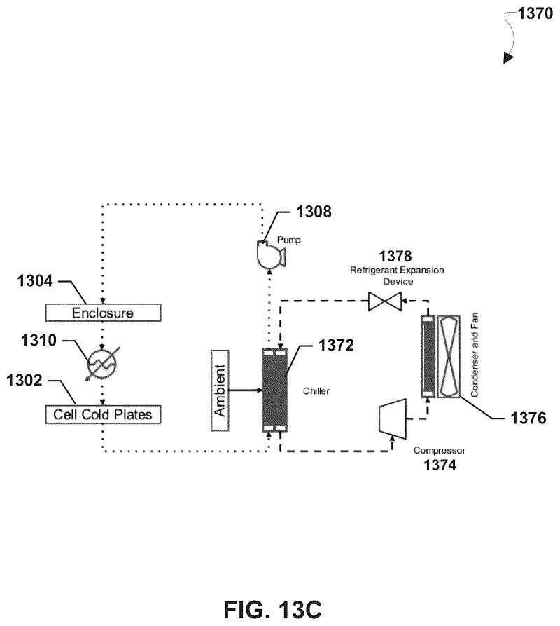

FIGS. 13A-13C illustrate embodiment thermal management systems that use liquid cooling. With reference to FIGS. 1-13C, FIG. 13A shows an embodiment thermal management system 1300 that includes cell cold plates 1302 as the cooling channels for the battery cells (e.g., cell(s) within cell enclosures 400) in a plurality of modules (e.g., modules 501, 502, 503, 504, 650, etc.) within an enclosure 1304 (e.g., 605, 710, etc.). The system 1300 also includes at least one pump 1308, and a liquid heater 1310.

With respect to a liquid cooling unit, the system 1300 may include a radiator 1306, as well as at least one air mover (e.g., fan). In various embodiments, ambient air may be drawn into the radiator 1306 by the fan(s). The various components of the embodiment thermal management system 1300 may be located in an auxiliary area, such as auxiliary area 608, 703, and/or distributed across multiple auxiliary areas, such as partially in auxiliary area 608 and partially in auxiliary area 703.

As shown in FIG. 13B, an alternative thermal management system 1350 may include a cooling tower 1352 to function as the liquid cooling unit for heat rejection. In some embodiments, air may be exhausted from the cooling tower 1352 into the environment outside the enclosure 1304. The various components of the embodiment thermal management system 1350 may be located in an auxiliary area, such as auxiliary area 608, 703, and/or distributed across multiple auxiliary areas, such as partially in auxiliary area 608 and partially in auxiliary area 703

Further, as shown in FIG. 13C, another alternative thermal management system 1370 may include a chiller circuit to function as the liquid cooling unit for heat rejection. In various embodiments, the chiller circuit may include a chiller 1372, a compressor 1374, a condenser 1376, at least one air mover (e.g., fan), and a refrigerant expansion device 1378. In various embodiments, the refrigerant expansion device 1378 may be, for example, a thermal expansion valve, an electronic expansion valve, or a sized orifice for the refrigerant. In various embodiments, ambient air from outside the enclosure may be drawn into the chiller 1372. The various components of the embodiment thermal management system 1370 may be located in an auxiliary area, such as auxiliary area 608, 703, and/or distributed across multiple auxiliary areas, such as partially in auxiliary area 608 and partially in auxiliary area 703.

Various embodiments may include a battery system comprising: a plurality of metal-air batteries, wherein each metal-air battery comprises: at least one air electrode, a metal electrode; a liquid electrolyte separating the at least one air electrode from the metal electrode; and a vessel including the liquid electrolyte; an enclosure housing the plurality of metal-air batteries; and an air circulation system, comprising: at least one fan configured to cycle air within the enclosure; wherein the plurality of metal-air batteries are configured to pull conditioned air from the enclosure and/or be pushed conditioned air from the enclosure. In various embodiments, the at least one fan comprises an exhaust blower configured to move hot air from the plurality of metal air batteries through channels to outside the enclosure. In various embodiments, the air circulation system further comprises an evaporation cooler at an inlet of a duct to condition air entering the enclosure. In various embodiments, the at least one fan is positioned at the inlet of a duct entering the enclosure or at an outlet of a duct leading from the enclosure. In various embodiments, the air circulation system further comprises: an air heating coil; and a recirculation path valve configured to move the air heated by the air heating coil through the enclosure when operating below a threshold temperature.

Various embodiments may include a battery system comprising: a plurality of metal-air batteries, wherein each metal-air battery comprises: at least one air electrode; a metal electrode; a liquid electrolyte separating the at least one air electrode from the metal electrode; and a vessel including the liquid electrolyte; an enclosure housing the plurality of metal-air batteries; and an air circulation system, comprising: a heating, ventilation, and air conditioning (HVAC) unit configured to pump cooled air into the enclosure, wherein the plurality of metal-air batteries are configured to: pull the cooled air from the enclosure; and exhaust hot air. In various embodiments, the hot air exhausted from the metal-air batteries is vented outside the enclosure. In various embodiments, the hot air exhausted from the metal-air batteries is recirculated to the HVAC unit. Various embodiments further comprise at least one fan configured to move air through channels within the enclosure. In various embodiments, the HVAC unit comprises an evaporator, a compressor, a condenser, at least one fan, and a refrigerant expansion device.

Various embodiments may include a battery system comprising: a plurality of metal-air batteries, wherein each metal-air battery comprises: at least one air electrode; a metal electrode; a liquid electrolyte separating the at least one air electrode from the metal electrode; and a vessel including the liquid electrolyte; an enclosure housing the plurality of metal-air batteries; and a liquid cooling system, comprising: a set of cooling channels on the surface of the plurality of metal-air batteries; a pump configured to move liquid through the cooling channels to condition the plurality of metal-air batteries; a heat rejection unit; and a liquid heating unit, wherein the heat rejection unit and the liquid heating unit are configured to treat the liquid used to condition the plurality of metal-air batteries, and wherein the treated liquid is recirculated to the set of cooling channels.

In various embodiments, the liquid heating unit comprises a water immersion heater outside the enclosure. In various embodiments, the heat rejection unit comprises a radiator and a fan. In various embodiments, the heat rejection unit comprises a cooling tower. In various embodiments, the heat rejection unit comprises a chiller circuit, and wherein the chiller circuit includes a compressor, a condenser, a chiller, a fan, and a refrigerant expansion device. In various embodiments, the metal-air batteries comprise iron-air type battery cells, zinc-air type battery cells, and/or lithium-air battery cells.

The foregoing method descriptions and the process flow diagrams are provided merely as illustrative examples and are not intended to require or imply that the steps of various embodiments should be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular. Herein, “about” may refer to a range of +/−5%.

Further, any step of any embodiment described herein can be used in any other embodiment. The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A battery system comprising:
a plurality of metal-air batteries, wherein each metal-air battery comprises:
at least one air electrode;
a metal electrode;
a liquid electrolyte separating the at least one air electrode from the metal electrode; and
a vessel including the liquid electrolyte;
an enclosure housing the plurality of metal-air batteries; and
an air circulation system, comprising:
at least one fan configured to cycle air within the enclosure;
wherein the plurality of metal-air batteries are configured to pull conditioned air from the enclosure and/or be pushed conditioned air from the enclosure.

2. The battery system of claim 1, wherein the at least one fan comprises an exhaust blower configured to move hot air from the plurality of metal air batteries through channels to outside the enclosure.

3. The battery system of claim 1, wherein the air circulation system further comprises an evaporation cooler at an inlet of a duct to condition air entering the enclosure.

4. The battery system of claim 1, wherein the at least one fan is positioned at the inlet of a duct entering the enclosure or at an outlet of a duct leading from the enclosure.

5. The battery system of claim 1, wherein the air circulation system further comprises:
an air heating coil; and
a recirculation path valve configured to move the air heated by the air heating coil through the enclosure when operating below a threshold temperature.

6. The battery system of claim 1, wherein the metal-air batteries comprise iron-air type battery cells, zinc-air type battery cells, and/or lithium-air battery cells.

7. A battery system comprising:
a plurality of metal-air batteries, wherein each metal-air battery comprises:
at least one air electrode;
a metal electrode;
a liquid electrolyte separating the at least one air electrode from the metal electrode; and
a vessel including the liquid electrolyte;
an enclosure housing the plurality of metal-air batteries; and
an air circulation system, comprising:
a heating, ventilation, and air conditioning (HVAC) unit configured to pump cooled air into the enclosure,
wherein the plurality of metal-air batteries are configured to:
pull the cooled air from the enclosure; and
exhaust hot air.

8. The battery system of claim 7, wherein the hot air exhausted from the metal-air batteries is vented outside the enclosure.

9. The battery system of claim 7, wherein the hot air exhausted from the metal-air batteries is recirculated to the HVAC unit.

10. The battery system of claim 7, further comprising at least one fan configured to move air through channels within the enclosure.

11. The battery system of claim 7, wherein the HVAC unit comprises an evaporator, a compressor, a condenser, at least one fan, and a refrigerant expansion device.

12. The battery system of claim 7, wherein the metal-air batteries comprise iron-air type battery cells, zinc-air type battery cells, and/or lithium-air battery cells.

13. A battery system comprising:
a plurality of metal-air batteries, wherein each metal-air battery comprises:
at least one air electrode;
a metal electrode;
a liquid electrolyte separating the at least one air electrode from the metal electrode; and
a vessel including the liquid electrolyte;
an enclosure housing the plurality of metal-air batteries; and
a liquid cooling system, comprising:
a set of cooling channels on the surface of the plurality of metal-air batteries;
a pump configured to move liquid through the cooling channels to condition the plurality of metal-air batteries;
a heat rejection unit; and
a liquid heating unit,
wherein the heat rejection unit and the liquid heating unit are configured to treat the liquid used to condition the plurality of metal-air batteries, and
wherein the treated liquid is recirculated to the set of cooling channels.

14. The battery system of claim 13, wherein the liquid heating unit comprises a water immersion heater outside the enclosure.

15. The battery system of claim 13, wherein the heat rejection unit comprises a radiator and a fan.

16. The battery system of claim 13, wherein the heat rejection unit comprises a cooling tower.

17. The battery system of claim 13, wherein the heat rejection unit comprises a chiller circuit, and wherein the chiller circuit includes a compressor, a condenser, a chiller, a fan, and a refrigerant expansion device.

18. The battery system of claim 13, wherein the metal-air batteries comprise iron-air type battery cells, zinc-air type battery cells, and/or lithium-air battery cells.
